(19) United States
(12) Patent Application Publication
(10) Pub. No.: US 2019/0260323 A1
(43) Pub. Date: Aug. 22, 2019

(54) LINEAR VIBRATION MOTOR

(71) Applicant: NIDEC COPAL CORPORATION, Tokyo (JP)

(72) Inventor: Hiroyuki HIDENAGA, Tokyo (JP)

(73) Assignee: NIDEC COPAL CORPORATION, Tokyo (JP)

(21) Appl. No.: 16/342,149

(22) PCT Filed: Oct. 10, 2017
(86) PCT No.: PCT/JP2017/036693

§ 371 Date: Apr. 15, 2019

(30) Foreign Application Priority Data
Oct. 13, 2016 (JP) 2016-201948

(51) Int. Cl. H02P 25/032; H02K 33/02; G08B 6/00

(52) U.S. Cl. CPC H02P 25/032; G08B 6/00; H02K 33/02

(57) ABSTRACT

A linear vibration motor comprising a frame, and a magnet and a weight, and also comprising a movable element that is supported elastically, so as to enable vibration along an axial direction, in respect to the frame, and a driving coil, secured to the frame, for applying a thrust, along the axial direction, to a magnet, through application of power, wherein a vibration characteristic that is measured through application of electric power to the driving coil is recorded in a recording medium that is provided on a frame.

### CROSS-REFERENCE TO RELATED APPLICATIONS

This Application is a National Stage of International Application PCT/JP2017/036693 filed Oct. 10, 2017, which claims priority to Japanese Application No. 2016-201948 filed Oct. 13, 2016. The above applications are incorporated herein by reference in their entirety.

### FIELD OF TECHNOLOGY

The present invention relates to a linear vibration motor.

### BACKGROUND

Vibration motors (or “vibration actuators”) are built into mobile electronic devices, and are broadly used as devices to communicate to the user, through a vibration, that there is an incoming call, or that a signal, such as an alarm, has been generated, and have become indispensable devices in wearable devices, which are carried on the body of the user. Moreover, in recent years vibration motors have been of interest as devices by which to achieve haptics (skin-sensed feedback) in the human interfaces such as touch panels.

Among the various forms of vibration motors that are under development, there is interest in linear vibration motors that are able to generate relatively large vibrations through linear reciprocating vibrations of a movable element. A conventional linear motor is provided with a magnet and a weight on a movable element side, where an electric current is applied to a coil that is provided on the stator side to cause the Lorentz forces that act on the magnet to form a driving force, to cause the movable element, which is elastically supported along the direction of vibration, to undergo reciprocating vibrations in the axial direction (referencing Japanese Unexamined Patent Application Publication 2016-13554).

When this type of linear vibration motor is mass-produced, there will be slight variability in the vibration characteristics, notwithstanding thorough quality control. There are many causes for this variability, such as component precision, processing conditions, and the like, making it difficult to suppress completely. In response, inspection standards are established, and only those products that satisfy the inspection standards are shipped as conforming products, where the rate at which defective products, those which do not satisfy the inspection standards, are produced has a large effect on product costs.

On the other hand, the variability in vibration characteristics in mass-produced products is smoothed by adjusting the driving signals. At present, in adjusting the driving signals, the behavior of vibrations is ascertained through various types of sensors (aperture sensors, three-axis acceleration sensor, and the like), and output voltage, frequency, rise slope, and the like, are adjusted in real time based on the data detected by the various types of sensors. Because of this, it is necessary to provide various types of sensors, which is costly, and although this can improve the yield, through smoothing the characteristics through adjustments, there is a problem in that this increases the packaging costs, including the provision of the various types of sensors. Moreover, there is a problem in securing room for the provision of the various types of sensors.

When such adjustments to driving signals are made through a controlling portion (control processor) of the electronic device main unit that is packaged with the linear vibration motor, the controlling portion performs calculation processes on the data detected by the various sensors, and, in response, controls the frequency and voltage values for the driving signals in real time, where a great deal of the processing capability of the controlling portion is spent on adjusting the driving signal of the linear vibration motor, preventing application of adequate processing capability to controlling the operations of the electronic device itself.

Moreover, the adjustments to the driving signals for the linear vibration motor are not only for smoothing the variability in the vibration characteristics, but, in addition, there is the need for correcting vibration characteristics depending on various applications. For example, there is the need for a variety of vibration characteristics depending on the state of the sensory feedback, in order to produce tactile effects in haptics, for example, effectively.

The present invention is proposed in order to handle problems such as these. That is, objects of the present invention include achieving a reduction in production costs through improving yields in mass-produced products, suppressing packaging costs when packaging the linear vibration motor, achieving an improvement in space utilization efficiency, enabling adjustments to driving signals in order to produce various types of vibration characteristics without sacrificing the ability to control operations in the electronic device in which the linear vibration motor is installed, and the like.

### SUMMARY

In order to solve such a problem, the linear vibration motor according to the present invention is provided with the following structures:

A linear vibration motor includes a frame; a movable element equipped with a magnet and a weight, and also that is supported elastically, so as to enable vibration along an axial direction, to the frame; and a driving coil, secured to the frame, for applying a thrust, along the axial direction, to the magnet, through application of electric power, wherein: a vibration characteristic, measured through applying electric power to the driving coil, is recorded in a recording medium that is provided on the frame.

### BRIEF DESCRIPTIONS OF THE DRAWINGS

FIG. 1 is an explanatory diagram illustrating a linear vibration motor according to an embodiment according to the present invention.

FIG. 2 is an explanatory diagram illustrating a linear vibration motor according to another embodiment according to the present invention.

FIG. 3 is an explanatory diagram depicting the state of characteristic correction in a calculation processing portion.

FIG. 4 is an explanatory diagram depicting one example of characteristic correction in a calculation processing portion.

FIG. 5 is an explanatory diagram illustrating a mobile electronic device in which is provided a linear vibration motor according to an embodiment according to the present invention.

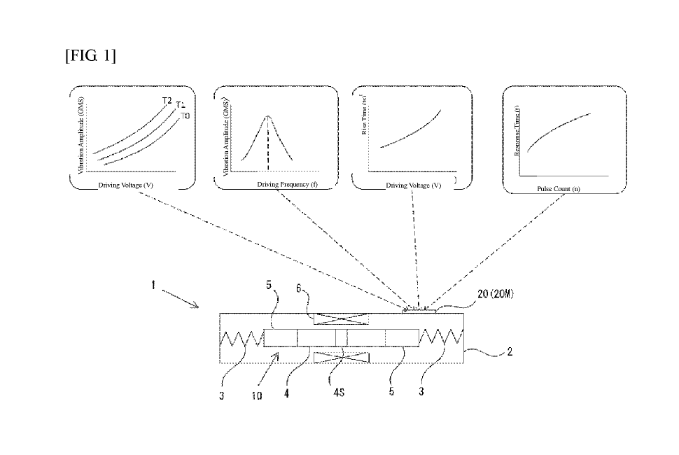

Embodiments according to the present invention will be explained below in reference to the drawings. In the descriptions below, identical reference symbols in the different drawings below indicate positions with identical functions, and redundant explanations in the various drawings are omitted as appropriate.

A linear vibration motor 1 comprises a frame 2, which serves as a stationary element, and a movable element 10 that is contained within the frame 2. While, in the diagram, the frame 2 is depicted, as an example, as a rectangular frame (box-shaped), the shape thereof is not limited thereto. The movable element 10 is supported elastically so as to enable vibration, along the axial direction, in respect to the frame 2. In an example, the movable element 10 is born slidably along a guide shaft, or the like, along the axial direction, where elastic members 3 (for example, compression coil springs or leaf springs) are disposed between the movable element 10 and the frame 2, so that when the movable element 10 vibrates in the axial direction, elastic repelling forces will be applied to the movable element 10.

The movable element 10 is equipped with a magnet 4 and a weight 5. In the example in the figure, the movable element 10 is equipped with a pair of weights 5 along the axial direction, and a magnet 4 is located between the pair of weights 5. A driving coil 6 is secured, in respect thereto, to the frame 2. The driving coil 6 and the magnet 4 are arranged so that a thrust, along the axial direction, is applied to the magnet 4, which is secured to the movable element 10, through the Lorentz force that is produced through application of power to the driving coil 6. In the example in the figure, the pair of magnets 4, which are magnetized along the axial direction, is arranged with identical poles near to each other, with a spacer (or a yoke) 4S disposed between the two magnets, and the driving coil 6 is wrapped onto the periphery of the spacer 4S. The layout relationship between the driving coil 6 and the magnet 4 is not limited to the example in the figure.

In this linear vibration motor 1, the movable element 10 is caused to undergo reciprocating vibration along the axial direction through application of an AC current (for example, a pulsed current) to the driving coil 6. Here the vibration characteristics of the movable element 10, in respect to a prescribed driving signal that is inputted to the driving coil 6, will vary depending on the precision of the components for the structural elements of the linear vibration motor 1, the processing conditions thereof, the precision of assembly, and the like, as described above. Because of this, when slight variability in the vibration characteristics are unavoidable, when the linear vibration motor 1 is mass-produced, or when linear vibration motors 1 having a variety of vibration characteristics are produced in mixed product production, manufacturing tolerance error in relation to the desired vibration characteristics is unavoidable.

In this regard, in the linear vibration motor 1 according to an embodiment according to the present invention, a recording medium 20, for recording the vibration characteristics of the individual unit, is provided on the frame 2. The vibration characteristics of each individual unit are measured through inputting a prescribed driving signal into the driving coil 6 after assembly of the linear vibration motor 1, and the data for the measured vibration characteristics is recorded in the recording medium 20. An example of the recording medium 20 is a semiconductor memory 20M; however, the recording medium 20 is not limited thereto, but rather it may be any readable information, such as text, a barcode, a QR code (registered trademark), or the like.

The information for the vibration characteristics that are recorded on the recording medium 20 may be, for example, data on the vibration amplitude (Grms) in relation to a driving voltage (V), data for the vibration amplitude (Grms) in respect to the driving voltage (V) at various ambient temperatures (T₀, T₁, T₂, . . . ), data for the vibration amplitude (Grms) in respect to the driving frequency (f), data for the driving frequency (resonant frequency f₀) wherein the vibration amplitude (Grms) will be maximized, data for the rise time (ts), in respect to the driving voltage (V), data for the response time (t) in respect to the pulse count (n pulses) after startup (step pulse response characteristics), and the like.

In this type of linear vibration motor 1, the recording medium 20, which records data for the vibration characteristics for each individual unit, on the frame 2 of each individual linear vibration motor 1, wherein there is variability in the vibration characteristics, enables the variability in the vibration characteristics in the mass-produced products to be smoothed through adjusting the driving signals using this data. These adjustments make it possible to suppress the rate at which defective products, those not satisfying inspection standards, are produced, and thus the linear vibration motor 1 enables an improvement in the yield of mass-produced products where there is variability in the vibration characteristics, enabling achievement of reduced production costs.

Moreover, the linear vibration motor 1 measures the vibration characteristics that are produced through application of power to the driving coil 6, and this measured data is recorded onto the recording medium 20, enabling the driving signal to be adjusted using the data that has been recorded in advance, thus eliminating the need for the variety of sensors for detecting, in real time, the behavior of the vibrations in order to adjust the driving signal. This eliminates the need to provide various types of costly sensors when packaging the linear vibration motor 1, and eliminates also the need for securing space for providing the various types of sensors, enabling an improvement in space utilization efficiency when packaging, along with reducing the packaging cost.

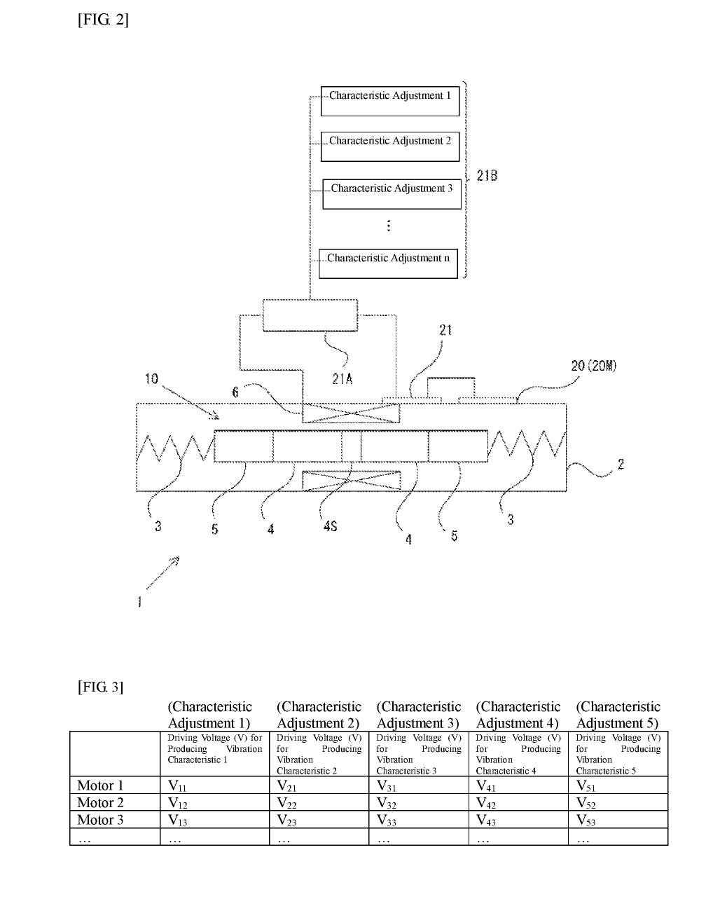

FIG. 2 depicts another embodiment of a linear vibration motor 1. In this linear vibration motor 1, a recording medium 20 (a semiconductor memory 20M) and a calculation processing unit 21 are provided on a frame 2. The calculation processing unit 21 reads in data that is recorded on the semiconductor memory 20M that is the recording medium 20, and outputs, to the driving coil 6, a driving signal wherein a calculation process has been performed based on this data.

The calculation processing unit 21 comprises a calculation processing portion 21A. The calculation processing portion 21A comprises a characteristic adjusting portion (characteristic adjusting program) 21B that reads in data from the semiconductor memory 20M that is the recording medium 20, and adjusts a variety of characteristics of the driving signal (characteristic adjustment 1, characteristic adjustment 2, characteristic adjustment 3, . . . , characteristic adjustment n).

As illustrated in FIG. 3, when the characteristic adjustments, described above (characteristic adjustment 1, characteristic adjustment 2, characteristic adjustment 3, . . . , characteristic adjustment 5) are performed, a driving voltage (V) is outputted to the individual linear vibration motor 1 that enables the specific vibration characteristics (vibration characteristic 1, vibration characteristic 2, . . . , vibration characteristic 5) to be produced.

Examples of vibration characteristics will be depicted here. For example, vibration characteristic 1 is a characteristic wherein the vibration amplitude when the rise is 10 ms, with a driving signal of a resonant frequency of f₀, will go to the set point (2 Grms), where the driving voltage (V) in order to produce this characteristic is set to V₁₁, V₁₂, and V₁₃, respectively, for motor 1, motor 2, and motor 3, through characteristic adjustment 1.

Vibration characteristic 2 is a characteristic that prevents the movable element 10 from colliding with the frame 2 when there is continuous vibration by a driving signal at the resonant frequency f₀, where the driving voltage (V) that is the maximum for obtaining this characteristic is set to V₂₁, V₂₂, and V₂₃, respectively, for the motor 1, motor 2, and motor 3, through characteristic adjustment 2.

The vibration characteristics 3, 4, and 5 are characteristics that are effective on the tactile effects of haptics, characteristics that produce vibration amplitudes in the respective scopes (for example, 1 Grms, 1.5 Grms, 2 Grms), when performing two-pulse driving, three-pulse driving, and four-pulse driving in pulsed driving. The driving voltages (V) in order to produce these characteristics are set to, respectively, V₃₁, V₄₁, and V₅₁ for motor 1, V₃₂, V₄₂, and V₅₂ for motor 2, and V₃₃, V₄₃, and the V₅₃ for motor 3.

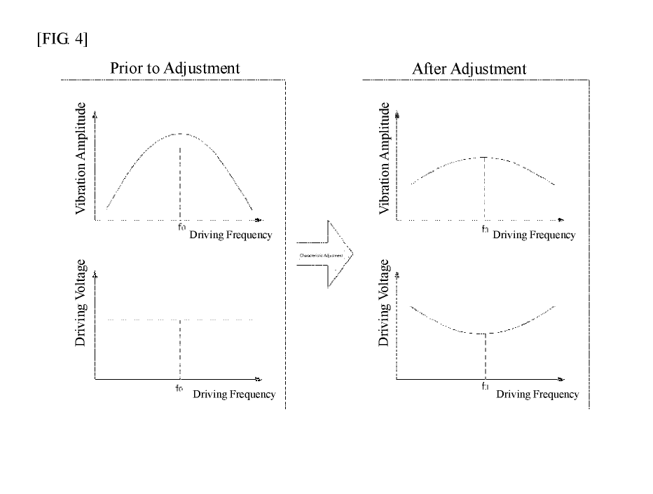

FIG. 4 depicts another example of characteristic adjustments performed by the calculation processing portion 21A described above. In this example, the linear vibration motor 1, prior to adjustment, has a vibration characteristic wherein the peak of the vibration amplitude is sharp in the vicinity of the resonant frequency of f₀ when a driving signal with that has a driving voltage that is unchanging in respect to the driving frequency is applied to the driving coil 6, and a characteristic adjustment is performed in order to produce a frequency response that is wider for the linear vibration motor 1. Here the change in vibration amplitude in respect to the driving frequency, after the adjustment, is smoothed through adjusting the driving voltage in relation to the driving frequency.

Specifically, at a frequency that is far from the resonant frequency f₀, the vibration amplitude is increased by increasing the driving voltage, and at frequencies near to the resonant frequency f₀, the vibration amplitude is reduced through reducing the driving voltage. Adjusting the driving voltage in this way makes it possible to do produce a linear vibration motor 1 that has a flatter frequency response. This broad frequency response characteristic is a characteristic adjustment that is effective for tactile repeatability in haptics.

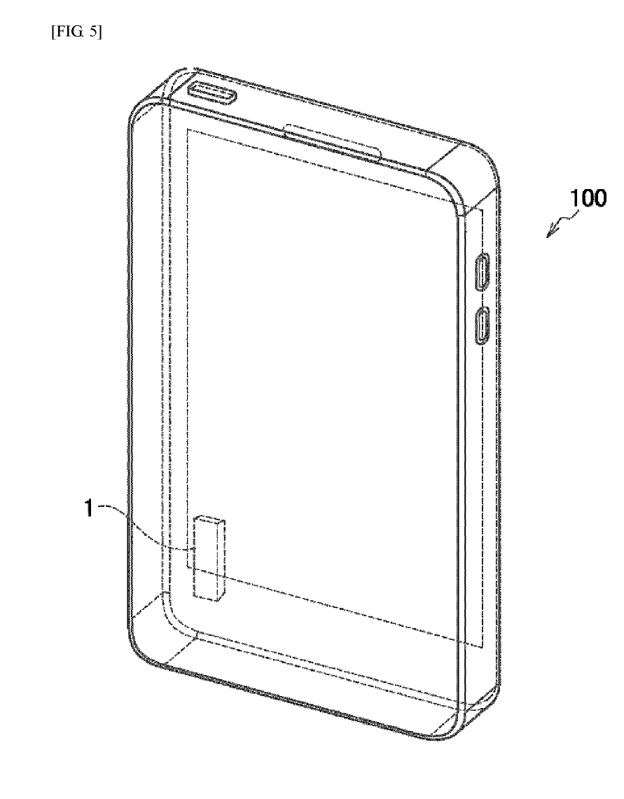

FIG. 5 depicts a mobile electronic device 100 (for example, a mobile information terminal such as a smart phone, a tablet terminal, or the like) wherein the linear vibration motor 1 according to an embodiment according to the present invention is mounted. The linear vibration motor 1 is able to suppress production costs through improving yields, and thus is able to suppress costs despite the mobile electronic device 100, in which it is mounted, being of high functionality.

Moreover, the linear vibration motor 1, through the provision of the calculation processing unit 21, described above, enables driving through a variety of vibration characteristics, enabling effective tactile effects in haptics. Because there is no need for the various types of sensors for detecting the various types of vibrations when mounting in the mobile electronic device 100, this can reduce the packaging cost, and can reduce the packaging space. Moreover, the vibration characteristics of the linear vibration motor 1 are adjusted through the equipped calculation processing unit 21, and thus the control unit of the mobile electronic device 100 itself is able to exhibit its full ability in controlling its own operations.

While embodiments according to the present invention were described in detail above, referencing the drawings, the specific structures thereof are not limited to these embodiments, but rather design variations within a range that does not deviate from the spirit and intent of the present invention are also included in the present invention. In particular, for the driving coil 6 and the magnets 4, the driving coil 6 may be provided on the movable element 10 side and the magnets 4 may be provided on the frame 2 side. Moreover, insofar as there are no particular contradictions or problems in purposes or structures, or the like, the technologies of the various embodiments described above may be used together in combination.

What is claimed is:

1. A linear vibration motor comprising:
a frame;
a movable element equipped with a magnet and a weight, and also that is supported elastically, so as to enable vibration along an axial direction, to the frame; and
a driving coil, secured to the frame, applying a thrust, along the axial direction, to the magnet, through application of electric power, wherein:
a vibration characteristic, measured through applying electric power to the driving coil, is recorded in a recording medium that is provided on the frame.

2. The linear vibration motor as set forth in claim 1, wherein:
the recording medium is a semiconductor memory.

3. The linear vibration motor as set forth in claim 2, wherein:
and for outputting, to the driving coil, a driving signal wherein a calculation process has been performed in accordance to the data, is provided on the frame.

4. The linear vibration motor as set forth in claim 1, wherein:
one of the vibration characteristics is a resonant frequency.

5. The linear vibration motor as set forth in claim 1, wherein:
one of the vibration characteristics is a vibration amplitude in respect to a driving voltage.

6. The linear vibration motor as set forth in claim 1, wherein:
one of the vibration characteristics is a rise time in respect to a driving voltage.

7. The linear vibration motor as set forth in claim 3, wherein:
the calculation processing unit comprises a calculation processing portion for carrying out a calculation process for adjusting a vibration characteristic based on data for a vibration characteristic recorded in the recording medium.

8. The linear vibration motor as set forth in claim 7, wherein:
a driving signal producing a vibration characteristic that has been adjusted by the calculation processing portion is a signal that is set so as to prevent the movable element from colliding with the frame.

9. A mobile electronic device comprising a linear vibration motor as set forth in claim 1.

10. A method for driving a linear vibration motor wherein a movable element is supported elastically, through an elastic member, on a frame, where a driving coil is provided on either the frame or the movable element and a magnet is provided on the other of the frame or the movable element,
measuring a vibration characteristic measured through applying electric power to the driving coil and recording on a recording medium provided on the frame;
reading in data that is recorded on the recording medium is read in;
calculating a driving signal wherein a calculation process has been performed in accordance with the data; and
outputting the driving signal to the driving coil.
